(19) United States
(12) Patent Application Publication
(10) Pub. No.: US 2021/0229966 A1
(43) Pub. Date: Jul. 29, 2021

(54) Systems and Methods for Winching a Load

(71) Applicant: Thomas M. Jones, St. Marys, WV (US)

(72) Inventor: Thomas M. Jones, St. Marys, WV (US)

(21) Appl. No.: 17/113,003

(22) Filed: Dec. 5, 2020

Related U.S. Application Data
(60) Provisional application No. 62/967,515, filed on Jan. 29, 2020.

(51) Int. Cl. B66D 1/36

(52) U.S. Cl. CPC B66D 1/36

(57) ABSTRACT

Certain embodiments of the disclosure can include methods, apparatus, and systems for winching a load. The embodiments can include coupling a cable to a vehicle. The cable can be extended and retracted via a motor. The embodiments can include a vertical mast extending, for example, above the height of the vehicle, and the mast can be coupled to the motor. The top end of the mast can include a pivotable pulley allowing, for example, winching a load located in any direction relative to the vehicle.

### CROSS-REFERENCE TO RELATED APPLICATION

This application claims the benefit of U.S. Provisional Application No. 62/967,515 filed Jan. 29, 2020.

### FIELD OF THE DISCLOSURE

The present invention is generally related to the field of winching.

### BACKGROUND

Both in business and in everyday life, heavy objects often need to be moved from one location to another. Often the relocation is merely from one end of the property to another, or from an off-road location back to the main road, or from one part of town to another, or from one city to a neighboring city. In these scenarios, the use of a vehicle is required if the objects are too heavy to lift and load manually.

Presently, winching a load from a vehicle can only be accomplished in two ways. The first way is to attach a winch to the bed of a pickup truck or all-terrain vehicle (ATV), with the extension of the cable being only in a single direction which is parallel to the longitudinal axis of the vehicle. The load, then, must be aligned with that axis also, and so the vehicle must be oriented to permit this alignment. Often, though, in rural areas or even in crowded developed areas, there is not sufficient maneuverability nor space to align the vehicle in such a manner relative to the load.

The second way to winch a load from a vehicle according to present inventions is to enlist a purpose-designed truck to accomplish the winching. These trucks are generally much larger than a pickup truck and, therefore, cannot access many areas where winching is needed, certainly not in any off-road situation. Furthermore, these large vehicles are prohibitively expensive for purchase by an individual or even a small business. Sometimes renting one of these vehicles could be worthwhile to the individual, but generally the high expense precludes the regular utilization by anyone but a large company whose business incorporates the use of such vehicles.

A solution is needed to meet the flexibility, affordability, and efficiency demanded for regular winching requirements.

### BRIEF SUMMARY OF THE DISCLOSURE

Some or all of the above needs and/or problems may be addressed by certain embodiments of the disclosure. Certain embodiments can include apparatus and methods for winching. According to one embodiment of the disclosure, there is disclosed an apparatus. The apparatus can include a cable strong enough to support the weight of whatever the user desires to move. The cable can be extended and retracted, around a spool for example, via a motor operable to rotate the spool, for example. The motor can be coupled to a mast extending away from the motor, along which axis the cable moves. The far end of the mast can be coupled to a pivotable pulley, through which the cable can run and be directed in accordance with the direction with which the pulley is pivoted.

According to another embodiment of the disclosure, there is disclosed a method. The method can include coupling a cable to a vehicle, and extending and retracting the cable via a motor. The method can include coupling a mast to the motor, along which the cable will run. The method can also include configuring one end of the mast with a pivotable pulley, and the extending and retracting can be in a direction in accordance with the pivoted direction.

According to another embodiment of the disclosure, there is disclosed a system. The system can include a winching motor coupled to a motor vehicle. The winching motor can be coupled to a mast. The system can include a pivotable pulley coupled to one end of the mast, through which the cable can run in a direction in accordance with the pivoted pulley.

Other embodiments, apparatus, methods, systems, aspects, and features of the disclosure will become apparent to those skilled in the art from the following detailed description.

### BRIEF DESCRIPTION OF THE DRAWINGS

The detailed description is set forth with reference to the accompanying drawings, which are not necessarily drawn to scale. The use of the same reference numbers in different figures indicate similar or identical terms.

FIG. 1A illustrates an example winching device, according to an embodiment of the disclosure, depicting rotation in a predominantly vertical direction.

FIG. 1B illustrates an example winching device, according to an embodiment of the disclosure, depicting rotation in a predominantly vertical direction.

FIG. 1C illustrates an example winching device, according to an embodiment of the disclosure, depicting rotation in a predominantly horizontal direction.

FIG. 1D illustrates an example winching device, according to an embodiment of the disclosure, depicting rotation in a predominantly horizontal direction.

FIG. 2A illustrates an example winching device, according to an embodiment of the disclosure, including a boom attachment.

FIG. 2B illustrates an example winching device, according to an embodiment of the disclosure, including a boom attachment.

FIG. 2C illustrates an example winching device, according to an embodiment of the disclosure, including a boom attachment.

FIG. 2D illustrates an example winching device, according to an embodiment of the disclosure, including a boom attachment.

FIG. 2E illustrates an example winching device, according to an embodiment of the disclosure, including a boom attachment.

FIG. 2F illustrates an example winching device, according to an embodiment of the disclosure, including a boom attachment.

FIG. 2G illustrates an example winching device, according to an embodiment of the disclosure, including a boom attachment.

FIG. 3 is a functional block diagram illustrating an example method of winching a load, according to an embodiment of the disclosure.

FIG. 4A illustrates an example winch including coupling, according to an embodiment of the disclosure.

FIG. 4B illustrates an example winch system coupled to a pickup truck, according to an embodiment of the disclosure.

FIG. 4C illustrates an example winch system coupled to a pickup truck, according to an embodiment of the disclosure.

FIG. 4D illustrates an example winch system towing a vehicle, according to an embodiment of the disclosure.

FIG. 4E illustrates an example winch system towing a vehicle, according to an embodiment of the disclosure.

FIG. 4F illustrates an example winch system for lifting a load, according to an embodiment of the disclosure.

FIG. 4G illustrates an example winch system with dump bed attachment, according to an embodiment of the disclosure.

FIG. 4H illustrates an example winch system with dump bed attachment, according to an embodiment of the disclosure.

FIG. 4J illustrates an example winch system with plow attachment, according to an embodiment of the disclosure.

FIG. 4K illustrates an example winch system with plow attachment, according to an embodiment of the disclosure.

FIG. 4L illustrates an example winch system with grass-cutting attachment, according to an embodiment of the disclosure.

FIG. 4M illustrates an example ATV winch system with hitch attachment, according to an embodiment of the disclosure.

FIG. 4N illustrates an example ATV winch system with hitch attachment, according to an embodiment of the disclosure.

FIG. 4P illustrates an example jeep winch system with hitch attachment, according to an embodiment of the disclosure.

FIG. 4R illustrates an example jeep winch system with hitch attachment, according to an embodiment of the disclosure.

FIG. 4T illustrates an example tractor winch system with hitch attachment, according to an embodiment of the disclosure.

FIG. 4U illustrates an example tractor winch system with hitch attachment, according to an embodiment of the disclosure.

FIG. 4W illustrates an example tow truck winch system with hitch attachment, according to an embodiment of the disclosure.

FIG. 4X illustrates an example boat winch system with hitch attachment, according to an embodiment of the disclosure.

FIG. 4Y illustrates an example boat winch system with hitch attachment, according to an embodiment of the disclosure.

### DETAILED DESCRIPTION

Illustrative embodiments of the disclosure will now be described more fully hereinafter with reference to the accompanying drawings, in which some, but not all, embodiments of the disclosure are shown. The disclosure can be embodied in many different forms and should not be construed as limited to the embodiments set forth herein; rather, these embodiments are provided so this disclosure will satisfy applicable legal requirements.

Certain embodiments disclosed herein relate to a winching apparatus. Accordingly, a winching apparatus can be provided to be used for lifting, transporting, and/or supporting special functions such as snow plowing, grass cutting, dumping, etc. For example, the winching apparatus can be attached to a vehicle such as a pickup truck, ATV, and JEEP®-type vehicle, among others. Any vehicle capable of receiving the coupling of a winch to it, and capable of supporting a load being winched, can accommodate the winching apparatus. The winching apparatus can be coupled to the vehicle in a central location that distributes the weight of the apparatus and any load near the vehicle's center of gravity. In some embodiments, the winch coupling can be located on the bed of a truck or utility vehicle, near the passenger compartment, for example. In other embodiments, the winch coupling can be located opposite the heavy engine compartment, in order to move the center of gravity of the vehicle closer to the geometric center of the vehicle.

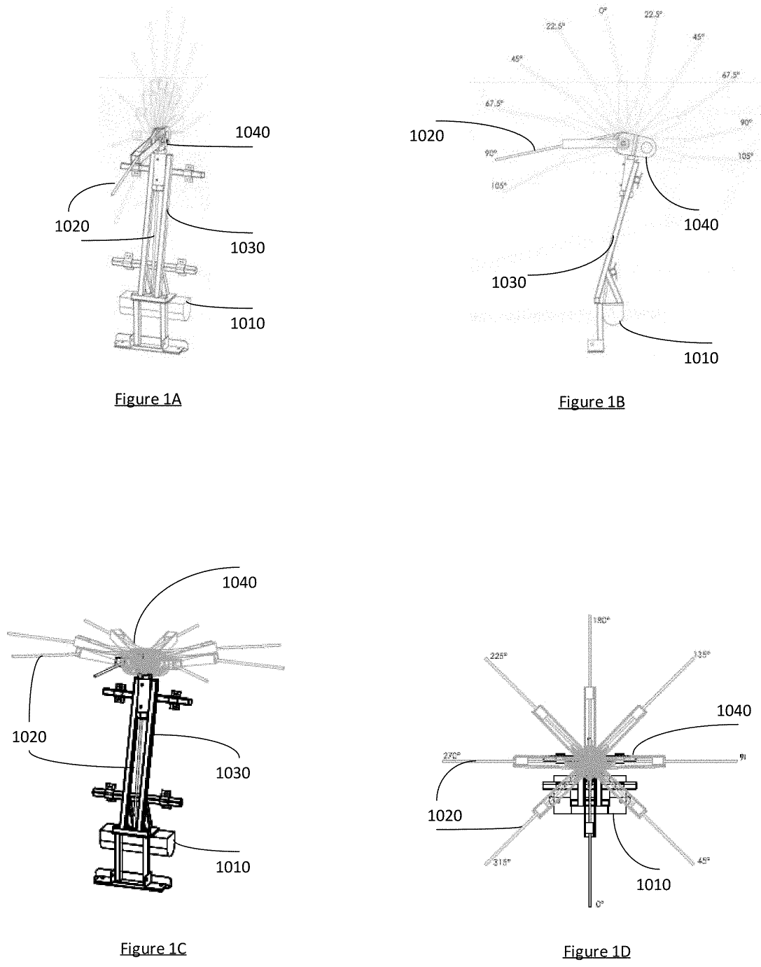

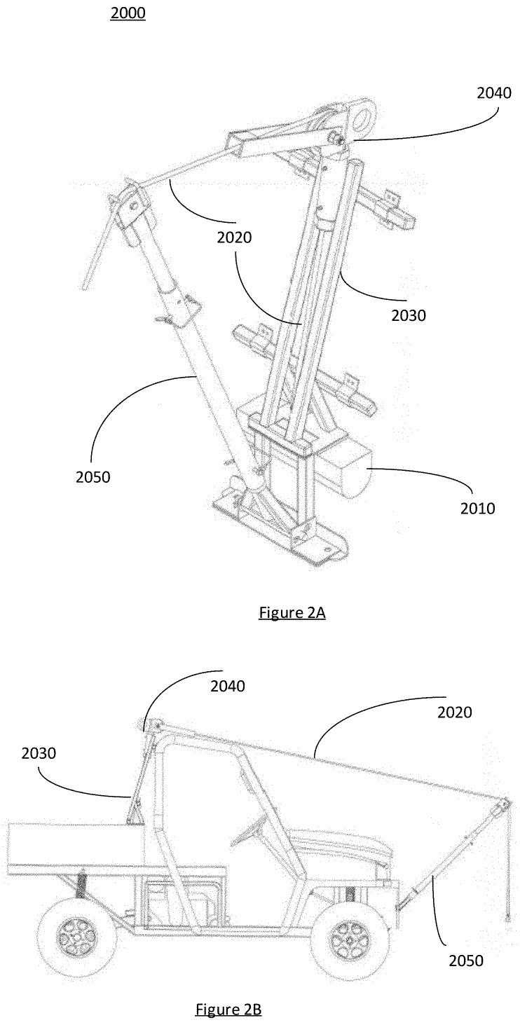

FIGS. 1A and 1B depict an example winching apparatus 1000 with substantially vertical rotation. The base, motor 1010, and mast 1030 of the apparatus 1000 can be essentially fixed in position while the pulley 1040 is operable for rotation. The pulley 1040 can rotate in any direction, and to any degree in that rotation. The rotatable pulley 1040 allows for winching from any direction. This is useful in situations, for example, where the vehicle to which the winch 1000 is attached cannot be oriented such that the vehicle aligns with the load, in addition to other situations where a pivotable pulley 1040 is useful.

For example, when the winch 1000 is coupled to a vehicle such that, by default, the winch 1000 is oriented along the longitudinal axis of the vehicle, this pivotable winch 1000 can still direct a cable 1020 in any direction toward a load via pulley 1040. If the winch 1000 is mounted on a pickup truck, but the truck remains on a road while the load is located off the road, then pivotable pulley 1040 can direct the cable 1020 toward the load, even though the truck maintains its longitudinal orientation on the road. Described another way, a vehicle such as a pickup truck can have the winching apparatus 1000 coupled to it, for example, near where the bed of the truck meets the cab. When the winch 1000 is firmly fixed to the truck, the mast 1030 and motor 1010 can be securely attached to prevent movement of those parts. Therefore, those parts can be rigidly oriented according to their attachment orientation and not easily moved later. In situations where this original orientation is not efficient, or not possible to utilize, pivotable pulley 1040 can be used regardless of the vehicle's orientation.

In some embodiments, pulley 1040 can be configured to run a single cable 1020 from motor 1010 to the load or fulcrum. Cable 1020 can run from motor 1010 along the axis of mast 1030 through pulley 1040 and out to the load. In some embodiments, mast 1030 can be adjustably telescoping. The pivotable pulley 1040 can direct cable 1020 along a straight route from mast 1030 to the load/fulcrum regardless of the location of the load relative to the orientation of the vehicle. In some embodiments, pulley 1040 can lock into place at the desired degree exactly toward the load or as close to the exact degree as possible. In other embodiments, pulley 1040 can rotate freely along one or more axes in order to maintain a straight-line pull even if the load or vehicle shifts during the extending or retracting of cable 1020. With reference to FIGS. 1A and 1B, pulley 1040 can rotate in a directional plane substantially perpendicular to the horizon, and can fully operate by extending and retracting a loaded cable 1020 at any of these substantially vertical degrees. Similarly, and with reference now to FIGS. 1C and 1D, pulley 1040 is rotatable in a substantially horizontal plane allowing for, for example, winching loads toward a latitudinal axis of the vehicle.

In some embodiments and in some directions, pulley 1040 can rotate on a low-friction material, such as ball bearings. In some embodiments, pulley 1040 can utilize a ratcheting mechanism to permit rotation and to lock in place and in some embodiments, rotatable pulley 1040 can use a ball and socket design to permit rotation. In some embodiments, more than one of these approaches can be used, depending on the direction of the rotation, or more than one can be used for rotation in a single direction.

Additionally, winch 1000 can include additional apparatus for purpose-driven tasks. In some embodiments, winch 1000 can include grass-cutting, plowing, and towing attachments. In lifting embodiments, winch 1000 can include additional structure for stability and support. The additional structures can be vertical supports comprised of multiple telescoping, and may be wheeled for mobile usage.

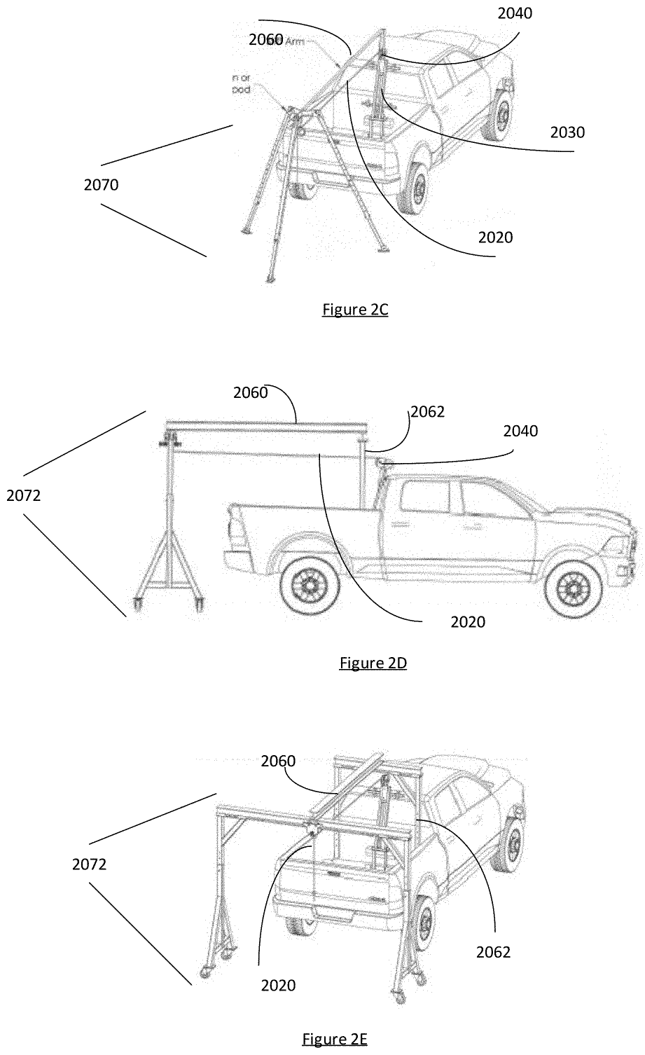

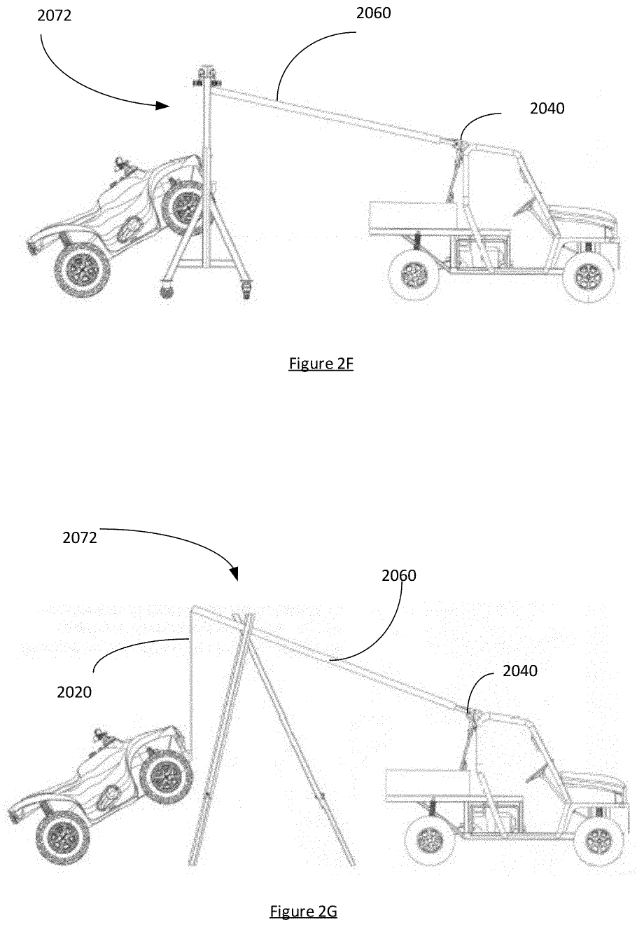

With reference now to FIGS. 2A-2G, winch 2000 can include a boom attachment 2050. In some embodiments, the boom attachment 2050 can include an arm coupled to the base of winch 2000. In some embodiments, this coupling at the base can include one or more hinges such that boom attachment 2050 is operable to swing in at least one directional plane. In some embodiments, both boom attachment 2050 and mast 2030 can be oriented in substantial alignment with the longitudinal axis of the vehicle. In this swinging direction, boom attachment 2050 can be locked at a particular angle, or it can move freely within one or more directional planes. Boom attachment 2050 can include a telescoping configuration such that its length can be extended and reduced as needed. The telescoping boom attachment 2050 can lock into place via push buttons or any other reasonable method for telescoping adjustments. Boom attachment 2050 can also include a pulley at its distal end, that is, its end opposite its coupling to the base of winch 2000. This boom attachment 2050 pulley can be fixed without rotation, or it can be rotatable. In some embodiments, the pulley of boom attachment 2050 can be rotatable about an axis that is substantially parallel with the axis of the boom arm 2050.

In addition to the functionality described above, and with reference now to FIG. 2B, boom attachment 2050 can also be mounted separately from mast 2030. In some embodiments, boom arm 2050 can be mounted on the front end of a vehicle irrespective of where the mast 2030 is mounted, including on the rear end or in the bed of the vehicle. It can be helpful to mount boom arm 2050 on the front end if the desired load or fulcrum will often be oriented toward the front of the vehicle. The front-mounted boom arm 2050 can also include a groove or channel attachment coupled to the roof of the vehicle such that cable 2020 runs through that channel and does not come in direct contact with the roof of the vehicle. Boom arm 2050 can be permanently fixed to a location such as the front end of the vehicle, or boom arm 2050 can be portable in that it can be moved to a mounting on the rear end or bed if one of those locations is preferable for a given task. The portable boom arm 2050 can simply be uncoupled from cable 2020, unmounted from its existing location, and then mounted in the new location. In some embodiments, a vehicle can include more than one boom arm 2050, either portable or fixed or both.

In some embodiments, and with reference now to FIG. 2C, the boom attachment can include a stiff arm 2060. The stiff arm 2060 can be a rigid bar made of metal or other durable material, and can be telescoping with adjustable length. Stiff arm 2060 can include a short vertical length, one end of which is attached, removably or permanently, to mast 2030 or to pulley 2040. In embodiments when stiff arm 2060 is coupled to pulley 2040, the stiff arm 2060 can rotate along with the pulley 2040 to reach a load in various directions. Toward the other end of stiff arm 2060 can be mounted an assembly 2070 for supporting the size, weight, and orientation of the desired load. In some embodiments, and as depicted in FIG. 2C, assembly 2070 can include a tripod apparatus. The tripod apparatus can include three legs of independently adjustable length, each with an independently adjustable foot. In use, cable 2020 can be extended and retraced substantially parallel tih mast 2030, through pulley 2040, substantially parallel with stiff arm 2060, and then down between the legs of the tripod.

In some embodiments, and with reference now to FIGS. 2D and 2E, winch 2000 can include a stiff arm 2060 that uses its own mast 2062, and with an assembly 2072 that includes two legs splayed toward the bottom, each leg ending in two wheeled feet. In this type of embodiment, stiff arm 2060 can be coupled to mast 2062 which can be coupled to the vehicle independent of the winching mast 2030. Mast 2062 can be coupled to the front end, rear end, bed, hitch, or any other vehicle region capable of accepting a mounting. The coupling of mast 2062 and stiff arm 2060 can be rotatable such that stiff arm 2060 can maintain a substantially parallel relationship relative to cable 2020 running through pulley 2040 while winch 200 is in use. In some embodiments, mast 2062 can include multiple legs and a cross bar to which stiff arm 2060 is coupled. Assembly 2072 can be constructed of any sufficiently rigid material such as metal or wood, suitable for the purpose. In some embodiments, some or all of the components of assembly 2072, stiff arm 2060, and mast 2062 can be composed of steel I-beams. Assembly 2072 can be configured with one or more wheels at its base to allow for, for example, rotation about the vehicle and transportation of the load when the vehicle is in motion.

In some embodiments, and with reference now to FIG. 2F, winch 2000 can be modular and scalable according to the needs and resources of a given situation. For example, assembly 2072 can be of a similar nature as the assembly illustrated in FIGS. 2D and 2E. Depicting, though, the use of an ATV or other small vehicle instead of the pickup truck illustrated in the previous Figures, some of the possible changes can be shown. For example, assembly 2072 can be similar in its legs, feet, wheels, and construction, although an of those features can be different and still comprise a winch apparatus 2000. Stiff arm 2060 coupled to assembly 2072 toward one end and coupled to pulley 2040 toward the other end. In some embodiments, stiff arm 2060 can serve as a conduit for the winching cable.

In some embodiments, and with reference now to FIG. 2G, assembly 2072 can include two or more telescoping legs without feet. In some environments, such as rocks and mud, it may be easier to stabilize assembly 2072 with legs that end in a point at ground level. The legs can be independently telescoping, and can be joined at or toward their tops either permanently or temporarily. Stiff arm 2060 can then rest where the legs meet and can be coupled to that position via straps, latches, or such, or can be held in position by the force of gravity. Stiff arm 2060 can also serve as a conduit for cable 2020.

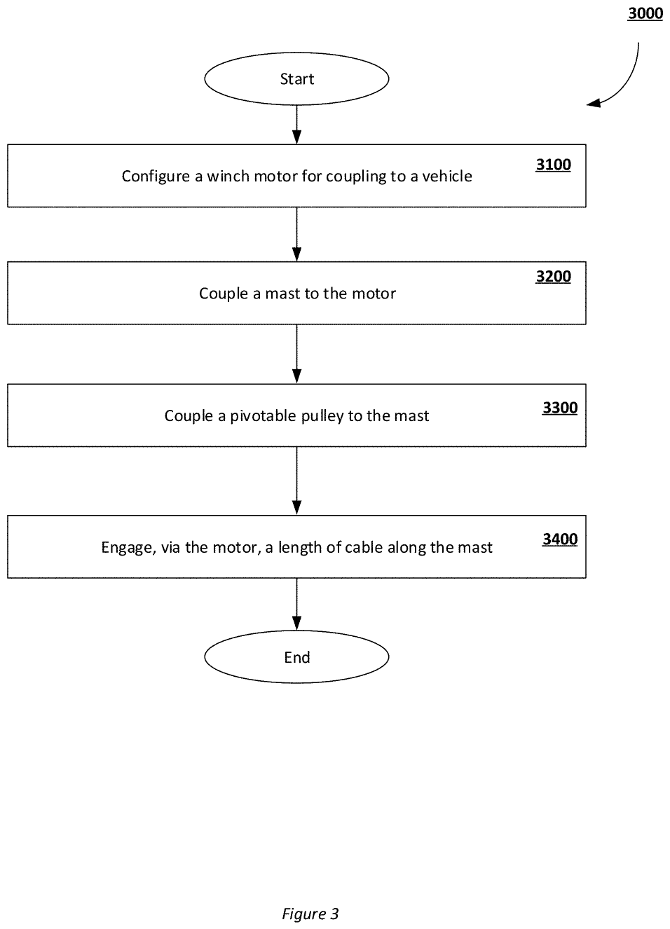

Referring now to FIG. 3, shown is a flow diagram of an example method 3000 for winching a load, according to an illustrative embodiment of the disclosure. The method can be utilized with various apparatus, such as winch 1000 and winch 2000 illustrated in FIGS. 1A-2G.

The method 3000 can begin at block 3100. At block 3100, a winch motor is configured to be coupled to a vehicle. The vehicle can be any vehicle suitable for the purpose including trucks, pickup trucks, ATVs, golf carts, and the like. A vehicle that includes a bed can be useful in many situations. The winch motor can be of any size and ability commercially available or custom designed. Winching method 3000 works with many different components, and is both modular and scalable. The motor should be coupled to the vehicle firmly, which can be achieved by bolting or welding. Often, the motor is bolted to a frame or base which is then coupled to the vehicle. In this way, the attached structure can be customized to the available dimensions of the vehicle without modifying the motor. This attached structure can include a base, a frame, and any other design necessary or desired by a particular person.

At block 3200, method 3000 can include coupling a mast to the motor. If the motor is first coupled to a base or frame, then this can be accomplished by coupling the mast to the base or frame. The mast should be constructed of a rigid material such as steel. In some embodiments, the mast can be telescoping and can lock firmly into place at different heights. In some embodiments, the top of the mast can extend above the highest surface of the vehicle, such as the roof, in order to permit winching in any direction. In some embodiments, method 3000 can include configuring the roof of the vehicle for ease in winching over it. For example, the winching cable can be channeled through a groove attachment coupled to the roof, and the cable can efficiently be extended and retracted along the groove. The groove attachment can be fixed permanently to the roof of the vehicle, or it can be used temporarily just for the duration of the winching.

At block 3300, a pivotable pulley can be coupled to the mast or winching structure. The pulley can be attached at the top of the mast to afford a fully rotatable winching device. The pulley can rotate 360 degrees horizontally, allowing for winching in any horizontal direction relative to the vehicle and winch. In some embodiments, the rotation can move freely between angles as the load or vehicle, or both, shift during winching. In other embodiments, the rotation angle can be selected and locked into place for winching. In general, this pivotable pulley is configured for both free rotation and angle-locking, and the user can choose one of those methods to employ, and change to the other if conditions dictate. The pulley can also rotate vertically, and can move freely or be locked into place in the vertical plane, depending on the winching situation. While the pulley can rotate 360 degrees vertically, in order to achieve 360-degree vertical winching, a mast arm must be used; otherwise, the location of the vehicle and the mast itself would interfere with the vertical rotation. The directional possibilities, then, of winching using method 3000 are spherical such that winching a load or fulcrum in any position relative to the vehicle and winch are achievable. Even with the addition of accessories, method 3000 can winch in any direction. For example, in embodiments that include a stiff arm, the stiff arm can be coupled to the rotatable pulley and thus be rotatable itself. In other embodiments, the stiff arm can be independent of the pulley, and have its own rotatability via a ball joint, etc., and in some embodiments the stiff arm can also serve as conduit for the winching cable. The stiff arm can telescope to varying lengths via movable sections, and can lock into place at the desired length when needed Similarly, a boom arm used in conjunction with method 3000 can rotate in any direction depending on its coupling with the vehicle or winch structure, and can vary in length with its telescoping design. In some embodiments, the boom arm can be coupled to the base of the winch via a ball joint or similar attachment. In most embodiments, the boom arm will include at least vertical rotation via a hinge attachment permitting boom arm movement in the vertical plane.

Method 3000 can also include various functionalities via the attachment of accessories to the winch. In addition to lifting a load or pulling on a fulcrum, method 3000 can also be adapted to, among other things, towing a vehicle. Depending on the power and weight of the vehicle to which the winching system is coupled, method 300 can be used to tow a passenger vehicle or ATV. For example, including a boom arm and sling with winching method 3000 can allow easy lifting and towing of an ATV. In some embodiments, method 3000 can be used as a dumping method. For example, a vehicle with a hinged bed capable of carrying material and being lifted, can be used to dump when method 3000 is configured to use the winch to latch onto one end of the bed and raise that end so that the material in the bed falls to the other end and exits the bed via a dump flap or other method. The dump bed can be coupled to a wheeled frame which is attached to the vehicle hitch, for example, or the dump bed can bypass the hitch and be coupled to the vehicle only by the winch. In some embodiments, method 3000 can be adapted to operate a snow plow. For example, the pulley can be rotated toward the front of the vehicle, and can lift or lower a front attachment via the winch. In some embodiments, a snow plow can be coupled to the front hitch of a vehicle and operation of the plow can rest solely with the extending or retracting of the winch cable. Of course, any plow coupled to the front end of a vehicle can be operated in this way, not only a snow plow. Similarly configured, a lawn mower can be coupled to the front hitch of a vehicle and raised or lowered for operation via the winch and front-facing pulley.

Method 3000 can be used with any vehicle capable of receiving the winching system, and the system can be coupled to the vehicle in a variety of locations. For example, an ATV, pickup truck, JEEP-type vehicle, and tractor are just some of the vehicles that can use method 3000 to extend the functionality of the vehicle. In some embodiments, method 3000 can include the use of a boom arm and a blade attachment, for example, for use in grading soil. This configuration and functionality can be utilized on any type of vehicle, including the tractor, JEEP, and ATV.

At block 3400, the motor can engage the winching cable up along the mast and through the rotatable pulley, and through the pulley and down the mast when retracting the cable. The path for the cable from winching motor, along the mast, through the pulley, along any accessories such as a stiff arm or boom arm, and ultimately out to the load or fulcrum are achieved by the coordinated configuration of these components in method 3000.

The operations described and shown in method 3000 of FIG. 3 can be carried out or performed in any suitable order as desired in various embodiments of the disclosure, and the method 3000 can repeat any number of times. Additionally, in certain embodiments, at least a portion of the operations can be carried out in parallel. Furthermore, in certain embodiments, fewer than or more than the operations described in FIG. 3 can be performed.

The method 3000 can optionally end following block 3400.

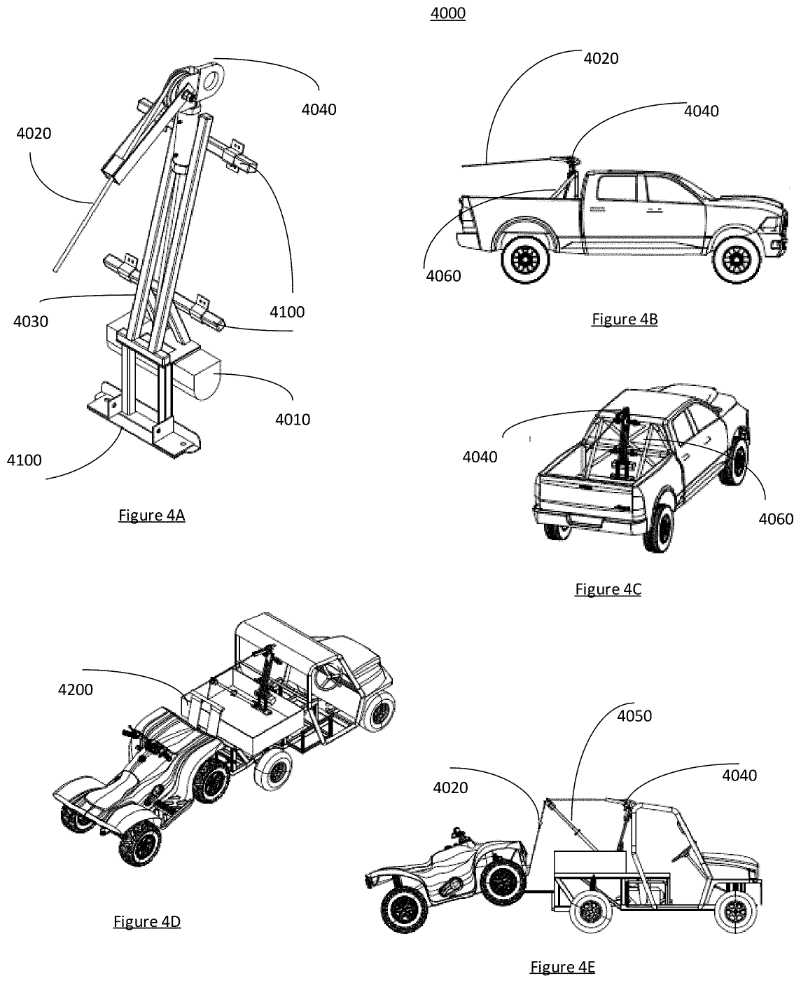

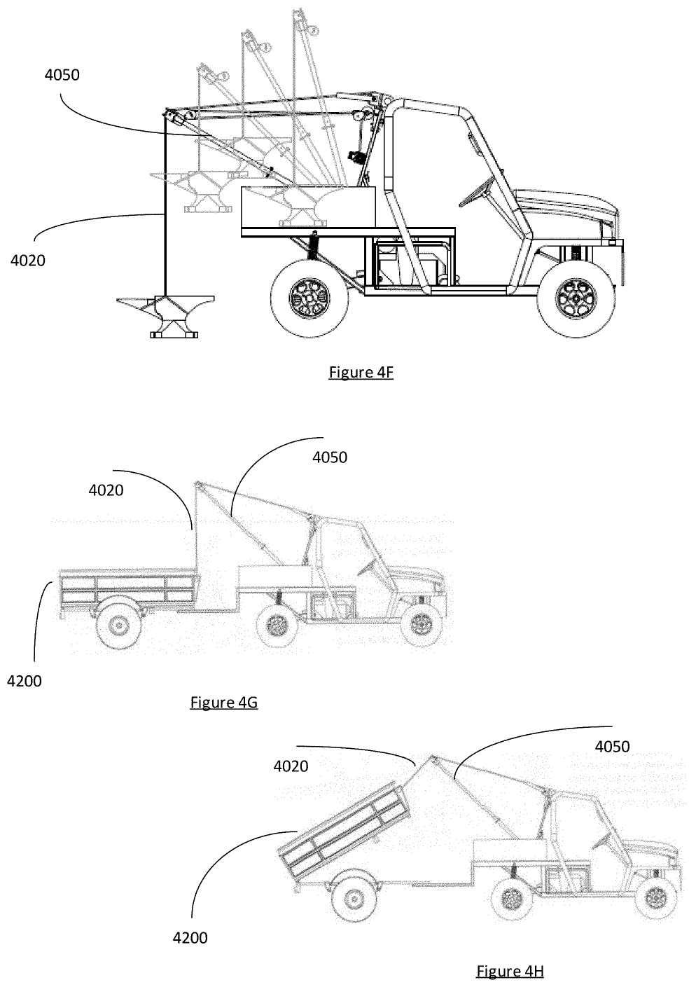

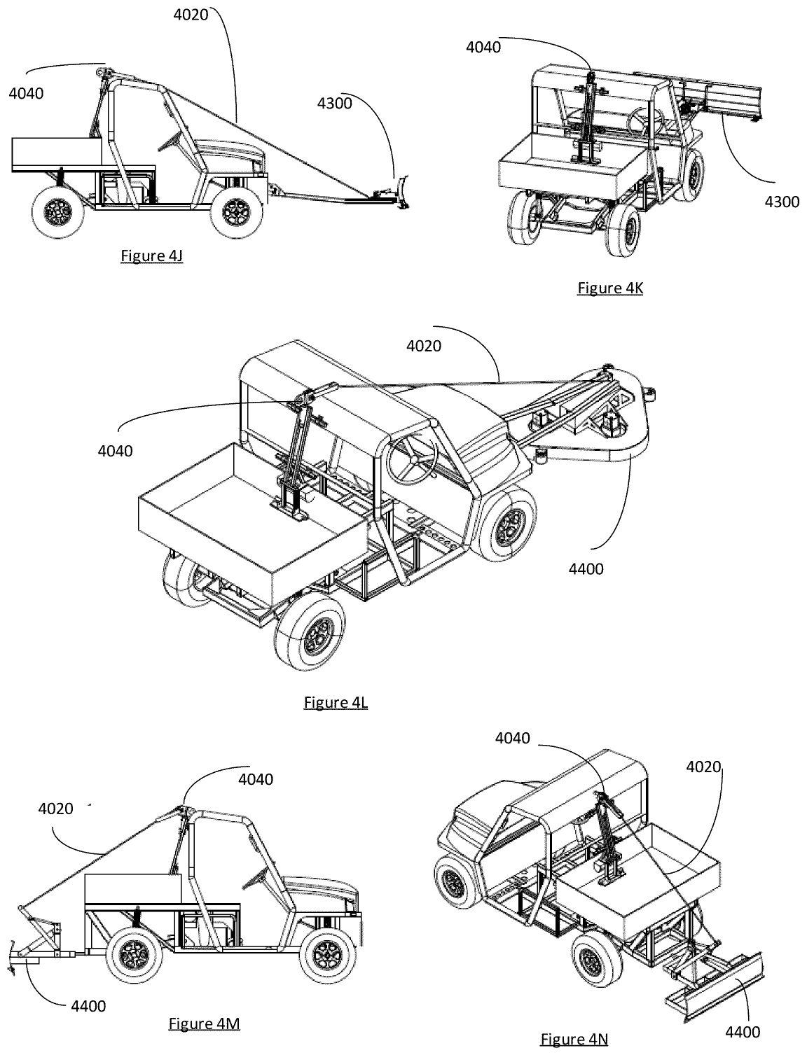

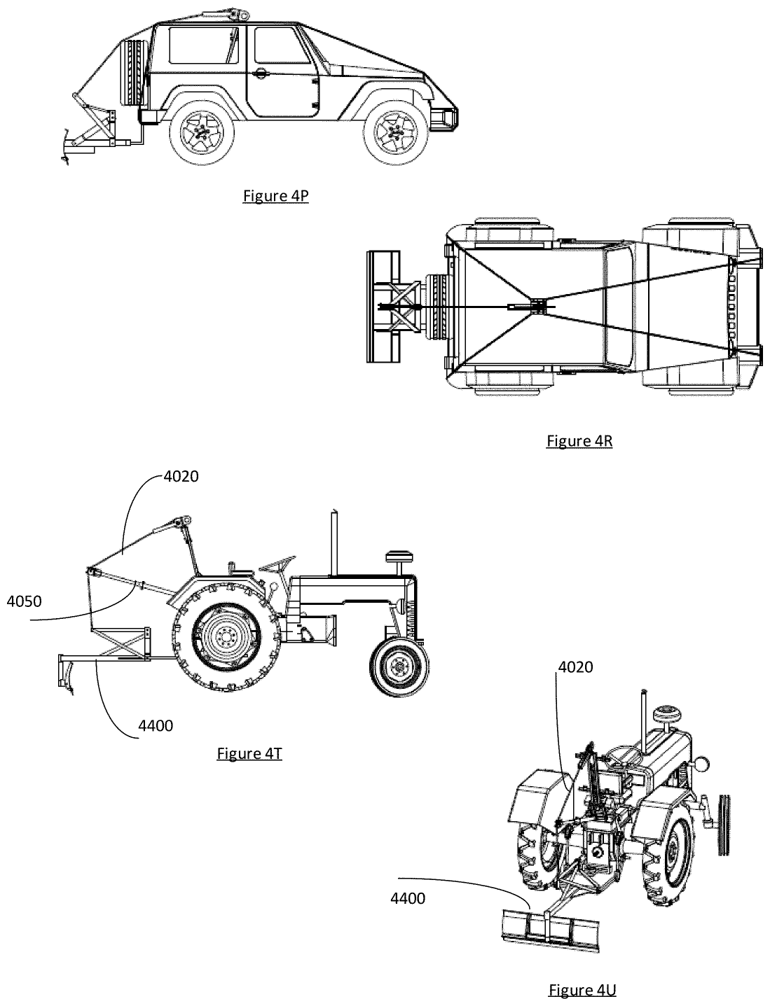

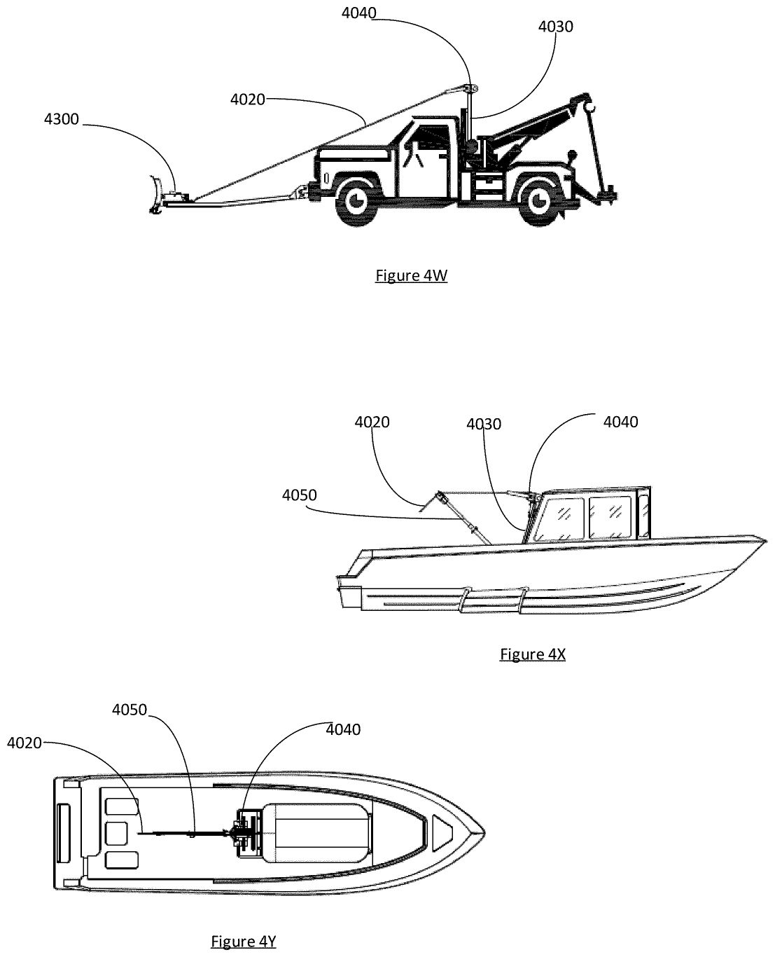

According to another embodiment of the disclosure, there is provided a system. For example, FIG. 4A depicts system 4000 that can be provided for winching from a vehicle. System 4000 can include all or some minimum number of the components of a winching apparatus, such as winching apparatus 1000, as well as other components for particular functions or for particular vehicles. System 4000 can include at least one winching motor 4010 and cable 4020. In some embodiments, system 4000 can include multiple winch motors and multiple cable lines. A winching apparatus can be coupled to a vehicle through bolting or similar attachment, and it can be welded to the vehicle. In some embodiments, coupling 4100 can securely bolt the winch to the vehicle, and can also manage the forces and stresses of heavy-duty winching, for example winching a heavy load such as another vehicle. Winching motor 4010 can be coupled, permanently or temporarily, to the winch frame, and mast 4030 can extend to above the roof of the vehicle either permanently or via telescoping. When mast 4030 extends above the roof of the vehicle, pulley 4040, which can fully rotate in any direction and to any degree, can be rotated 360 degrees in the horizontal plane, allowing for winching a load wherever it may be located relative to the vehicle. Coupling 4100 can be attached to the structural frame of the vehicle, which can be a pickup truck, ATV, JEEP-type vehicle, tractor, or any other vehicle capable of operating with winching system 4000.

With reference now to FIGS. 4B and 4C, some embodiments of system 4000 can include a coupling frame 4060 that can attach to both the vehicle and the winch. In this way, the winch can be coupled to the vehicle via the coupling frame. This approach can be used, for example, when a vehicle's structural points do not coincide with the locations of the winch's coupling bolts. Coupling frame 4060 can be customized to fit any vehicle, but since many vehicles are similar in design, only a few options for the coupling frame 4060 may be necessary. By ensuring the winch pulley 4040 enjoys free horizontal movement above the roof of the vehicle and above the top of coupling frame 4060, cable 4020 can then be extended and retracted without interference in any horizontal direction.

In some embodiments, and with reference now to FIGS. 4D and 4E, system 4000 can be used with an ATV to tow, for example, a vehicle such as another ATV. System 4000 can include boom arm 4050 which can extend or retract by telescoping and can rotate in a vertical plane substantially aligned with the route of cable 4020, for example. Boom arm 4050 telescoping can ensure the last length of cable 4020 is essentially purely vertical, ensuring a high efficiency in the winching. Cable 4020 can be coupled to a sling 4200, for example, such that sling 4200 forms a better coupling with the vehicle being towed than merely a cable and hook might. In this way, cable 4020, sling 4200, and boom arm 4050 can work together with the other system 4000 components to make lifting and towing of a vehicle more efficient.

In some embodiments, and with reference now to FIG. 4F, system 4000 can be used to lift and transport a load. For example, using the addition of only a boom arm 4050 along with the winch apparatus, a load can be secured with the cable 4020 and transported while hanging from the cable 4020, or can be lifted onto the bed or other appropriate surface of the vehicle. When the winch retracts cable 4020 and raises the load, boom arm 4050 also rises to accommodate the load in the vehicle. Similarly, when a load is moved from the bed or other surface of a vehicle to outside the vehicle, when the winch is engaged, the cable 4020 retracts and lifts the object from the bed. The object can then be guided away from the vehicle, and this will rotate boom arm 4050 as needed. In other embodiments, boom arm 4050 can be both fixed and adjustable, locking in place, for load situations where a stationary boom arm 4050 is preferred.

In another embodiment, and with reference now to FIGS. 4G and 4H, system 4000 can include functionality and components for a dump bed. By positioning boom arm 4050, via rotation and telescoping, such that its is essentially directly over the contact point between dump bed 4200 and cable 4020, efficient lifting can be achieved by winching system 4000. In some embodiments, cable 4020 can be coupled to the bottom of dump bed 4200 and, in some embodiments, cable 4020 can run through a pulley attached to the bed 4200. For example, dump bed 4200 can include a flap tailgate that can permit material to pass through when unlatched, as well as a hinge or other coupling with a wheeled frame to permit lifting one end of the dump bed 4200 so that the force of gravity will slide the material toward the flap tailgate. System 4000 can be coupled to dump bed 4200 via cable 4020, and dump bed 4200 can be lifted and emptied by retracting cable 4020 through the winch motor. After dumping the desired amount of material, dump bed 4200 can be lowered back onto its wheeled frame for transportation. In some embodiments, the vehicle can be in motion when dump bed 4200 is raised in order to distribute material over a wider area.

In another embodiment, and with reference now to FIGS. 4J, 4K, and 4W, system 4000 can be used with a plow attachment 4300, such as a snow plow. Plow 4300 can be coupled to the front hitch of the vehicle, whether the vehicle is a pickup truck, tow truck, ATV, tractor, or the like. The force of gravity would cause plow 4300 to rest on the ground, but by connecting cable 4020, the plow 4300 can be lifted off the ground when the vehicle is not plowing. Since pulley 4040 is located above the roof of the vehicle and is operable to rotate horizontally and vertically, cable 4020 can run directly to plow 4300 from pulley 4040. In some embodiments, a channel can be provided that is positioned on top of the roof for cable 4020 to pass through. In some embodiments, cable 4020 can be coupled directly to the top of plow 4300. In other embodiments, plow 4300 can include a vertical bar or attachment, which can be located in the front middle section of plow 4300, and which can provide a coupling for cable 4020 above the top surface of plow 4300. In some embodiments, the coupling of the vertical bar with cable 4020 can include a pulley at the top of the bar. In regular snow plowing, the winch can be engaged, cable 4020 extended, and plow 4300 lowered during the vehicle's forward pass on a snowy surface. Then the winch can be engaged, cable 4020 retracted, and plow 4300 raised while the vehicle is driving over the plowed surface and positioning for the next plowing row. This sequence can be repeated easily any number of times to make the job efficient and extend the use of any vehicle using the winching system 4000. In some embodiments, mast 4030 can extend above the roof of the vehicle either permanently or via telescoping. Among other functions, mast 4030 can extend well above the roof of the vehicle which can allow cable 4020 to go from pulley 4040 to attachment 4300 without encumbering differently sized or shaped vehicle roof, hood, etc. When mast 4030 extends above the roof of the vehicle, pulley 4040, which can fully rotate in any direction and to any degree, can be rotated for use of the attachment 4300 in a range of directions relative to the vehicle.

In another embodiment, and with reference now to FIG. 4L, a vehicle's utility can be extended via system 4000 with the addition of a grass-cutting attachment 4400. Similar to the usage of a snow plow attachment 4300 as described above, grass-cutting attachment 4400 can be coupled to a hitch of the vehicle, and it can be either a front or rear hitch. In some embodiments, cable 4020 can be coupled directly to the top of attachment 4400. In other embodiments, attachment 4400 can include a vertical bar or attachment, which can be located in the front middle section of attachment 4400, and which can provide a coupling for cable 4020 above the top surface of attachment 4400. In some embodiments, the coupling of the vertical bar with cable 4020 can include a pulley at the top of the bar. In order to raise attachment 4400 in between uses, the operator can engage the winch, retract cable 4020, and lift attachment 4400 off the ground. When mowing, the winch can be engaged, cable 4020 extended, and attachment 4400 lowered to the desired cutting level. Depending on the desired length of the grass, the cable 4020 can be extended or retracted as needed. Since pulley 4040 is fully rotatable and extends above the roof of the vehicle, mowing from either the front or rear hitch is possible. In embodiments using the front hitch, a groove can be provided and coupled to the roof of the vehicle to run cable 4020 through, if necessary or desired.

In other embodiments, and with reference now to FIGS. 4M-4U, the winching system 4000 can be adapted for a particular use and for a particular type of vehicle, while using the same components and methods. In some embodiments, slight modifications may be desired for a particular purpose or vehicle, but those modifications are inclusive in the modular and scalable system 4000. FIGS. 4M and 4N illustrate an example blade assembly 4400 used by winching system 4000. An ATV with system 4000 can include a blade assembly 4400 coupled, for example, to the ATV rear hitch. In some embodiments, assembly 4400 can be coupled to a three-point hitch. The blade 4400 can be lowered when cable 4020 is extended through pulley 4040 via the winching motor. The blade 4400 can remain lowered as needed for grading soil, and can be raised by engaging the winch motor and retracting cable 4020 which raises assembly 4400. With reference now to FIGS. 4P and 4R, blade assembly 4400 can be used with a JEEP®-type vehicle. Assembly 4400 can be coupled to, for example, the rear hitch of the vehicle, and the hitch can be a three-point hitch. In some embodiments, the winch mast can be telescoping, allowing for the pulley and the top of the winching apparatus to extend well above the roof of the vehicle and permit sufficient clearance of vehicle accessories, such as a spare tire. In other embodiments, the mast can be fixed with a height sufficient for clearance of vehicle accessories. With reference now to FIGS. 4T and 4U, blade assembly 4400 can also be utilized with a tractor or other farm vehicle. For example, system 4000 can include boom arm 4050 for, among other things, additional spacing between the vehicle and the blade assembly 4400. Assembly 4400 can be coupled to a rear hitch of the farm vehicle, and it can be a three-point hitch. System 4000 can lower the blade to the ground as desired by the operator engaging system 4000, extending cable 4020, which lowers assembly 4400. When including boom arm 4050, system 4400 can focus the forces directly downward from the endpoint of boom arm 4050 to make lifting or engaging assembly 4400 more efficient. Boom arm 4050 can be coupled to the winch mast or winch frame. In some embodiments, boom arm 4050 can be coupled separately to the vehicle. The boom arm 4050 can be telescoping to allow for different lengths for utility, and the end of boom arm 4050 can include a rotatable pulley that increases the ability to guide cable 4020 in the desired direction.

In some embodiments, and with reference now to FIGS. 4X and 4Y, system 4000 can be coupled with a boat or other marine vehicle. System 4000 can include boom arm 4050 which can extend or retract by telescoping and can rotate in a vertical plane substantially aligned with the route of cable 4020, for example. In embodiments including a telescoping boom arm 4050, system 4000 can winch a load such as a person, another boat, or a fishing net, just to name a few. The telescoping boom 4050, when extended, can expand the reach of system 4000 farther from the boat, and can lift winched objects higher when on the boat, for example, larger objects such as larger fish. In some embodiments, winch mast 4030 can be telescoping, allowing for the pulley 4040 and the top of the winching apparatus to extend well above the roof of the boat and permit sufficient clearance of the boat, and permit pulley 4040 to rotate around the highest points of the boat. In other embodiments, the mast 4030 can be fixed with a height sufficient for clearance of the top of the boat. In emergencies, cable 4020 can be attached to a fixed object, such as a tree or other boat, to remove the boat from being stuck or grounded, or otherwise providing mobility without relying on the boat motor.

As desired, embodiments of the disclosure may include systems with more or fewer components than are illustrated in the drawings. Additionally, certain components of the systems may be combined in various embodiments of the disclosure. The systems described above are provided by way of example only.

The above description presents the best mode contemplated for carrying out the present embodiments, and of the manner and process of practicing them, in such full, clear, concise, and exact terms as to enable any person skilled in the art to which they pertain to practice these embodiments. The present embodiments are, however, susceptible to modifications and alternate constructions from those discussed above that are fully equivalent. Consequently, the present invention is not limited to the particular embodiments disclosed. On the contrary, the present invention covers all modifications and alternate constructions coming within the spirit and scope of the present disclosure. For example, the steps in the processes described herein need not be performed in the same order as they have been presented, and may be performed in any order(s). Further, steps that have been presented as being performed separately may in alternative embodiments be performed concurrently. Likewise, steps that have been presented as being performed concurrently may in alternative embodiments be performed separately.

Now that these embodiments have been described,

What is claimed is:

1. A winching apparatus comprising:
a cable;
a motor to extend and retract the cable;
a mast coupled to the motor, a distal end of the mast coupled to a pivotable pulley.

2. The winching apparatus of claim 1, wherein the pivotable pulley is operable to pivot horizontally.

3. The winching apparatus of claim 1, wherein the pivotable pulley is operable to pivot vertically.

4. The winching apparatus of claim 1, wherein the mast is operable for telescopic extension.

5. The winching apparatus of claim 1, further comprising a boom arm coupled to the mast.

6. The winching apparatus of claim 5, wherein the boom arm is operable for telescopic extension.

7. The winching apparatus of claim 5, further comprising a vertical support coupled to a distal end of the boom arm.

8. A method of winching, the method comprising:
coupling a winching motor to a vehicle;
coupling a mast to the winching motor;
engaging, via the motor, a length of cable along the mast; and
coupling a pivotable pulley to the mast.

9. The method of claim 8, wherein the pivotable pulley is operable to pivot horizontally.

10. The method of claim 8, wherein the pivotable pulley is operable to pivot vertically.

11. The method of claim 8, wherein the mast is operable for telescoping.

12. The method of claim 8, further comprising directing the cable with a boom arm, wherein the boom arm is coupled to the mast.

13. The method of claim 12, wherein the boom arm is operable for telescoping.

14. The method of claim 12, further comprising coupling a vertical support to a distal end of the boom arm.

15. A winching system comprising:
a winching motor coupled to a motor vehicle;
a mast coupled to the winching motor; and
a pivotable pulley coupled to the mast.

16. The winching system of claim 15, further comprising a boom arm coupled to the mast.

17. The winching system of claim 16, wherein the boom arm is operable for telescoping.

18. The winching system of claim 16, further comprising a vertical support coupled to the mast.

19. The winching system of claim 15, further comprising a snow plow attachment coupled to the motor vehicle, the snow plow attachment operable via the winching motor.

20. The winching system of claim 15, further comprising a lawn-mowing attachment coupled to the motor vehicle, the lawn-mowing attachment operable via the winching motor.
